(19) United States
(12) Patent Application Publication
(10) Pub. No.: US 2010/0161474 A1
(43) Pub. Date: Jun. 24, 2010

(54) System and Method for Processing Failed Trades of Mortgage Backed Securities

(75) Inventors: Leonard C. Monteleone, Boca Raton, FL (US); James Fiorentino, Calabasas, CA (US)

Correspondence Address: ARNOLD & PORTER LLP;ATTN: IP DOCKETING DEPT., 555 TWELFTH STREET, N.W., WASHINGTON, DC, 20004-1206, US

(73) Assignee: CHAPDELAINE MBS LLC, New York, NY (US)

(21) Appl. No.: 12/635,286

(22) Filed: Dec. 10, 2009

Related U.S. Application Data
(63) Continuation of application No. 11/129,334, filed on May 16, 2005, now abandoned.
Application No. 11/129,334 is a division of application No. 10/735,749, filed on Dec. 16, 2003, now abandoned.

(51) Int. Cl. G06Q 40/00

(52) U.S. Cl. 705/37; 705/35

(57) ABSTRACT

The present invention provides a system and method for trading mortgage-backed securities (“MBS”). A system for trading includes a plurality of workstations interconnected by a server. The workstations receive data representing inventories of their MBS pools, which in turn are delivered to the server. The server, in turn, is operable to perform a transaction based on an analysis of the inventory. One type of transaction includes a consolidation of like MBS pools found in different inventories in order to reduce the size of the inventories.

### PRIORITY CLAIM

The present application is a divisional application of U.S. Non-Provisional patent application Ser. No. 10/735,749 filed Dec. 16, 2003, the contents of which are incorporated herein by reference.

### FIELD OF THE INVENTION

The present invention relates generally to securities and more particularly relates to a system and method for trading mortgage-backed securities.

### BACKGROUND OF THE INVENTION

Securities trading has benefited enormously from automated processing and settlement using computers. However, securities come in many different forms and so different automation techniques are used for different forms of securities. Generally, high demand securities, such as mutual funds, stocks and bonds, have undergone greater trading automation than others.

One class of securities that is increasingly in demand is mortgage-backed securities (“MBS”). In the year 2003, there have been times that the outstanding debt in the MBS industry has exceeded $3.0 trillion. Despite this demand, the processing and settlement techniques for MBS have remained relatively static over the last twenty-five years. As demand for MBS increases, there have increasingly been industry-wide delays and failures in transaction settlements.

Currently, MBS trades are processed in the following manner. Initial trades are done on a to-be-announced (“TBA”) basis, wherein the government agency, coupon, price and settlement date are identified (“TBA trade” or “Generic trade”). On the settlement date, the TBA trade is “pooled”, or converted into a specific pool trade that is identified with a unique pool number. The Government National Mortgage Association (“GNMA” or “Ginnie Mae”), the Federal National Mortgage Association (“FNMA” or “Fannie Mae”) and the Federal Home Loan Mortgage Corp (“FHLMC” or “Freddie Mac”) are three Agencies that package their mortgages into specific securities that are sold as specific pool securities in the over-the-counter (“OTC”) marketplace.

A specific example helps to further understand the foregoing prior art method of processing MBS trades. An example of a TBA trade or Generic trade is a GNMA, 6.0%, $1 million, for settlement on Jul. 15, 2003. More particularly, GNMA is the Agency, 6.0% is the Coupon, $1 million is the value of the trade, and Jul. 15, 2003 is the settlement date. This TBA trade, in turn, will settle into a specific pool trade as of Jul. 15, 2003. The specific pool trade will detail the pool number and the current value of the pool. Those of skill in the art will recognize that, in this example, industry guidelines specify that three pools, each having a minimum original face value of $25,000 but collectively totalling $1 million, and within a variance of plus or minus 0.01%, will be considered a “good” delivery of this TBA trade.

To effect the conversion of TBA trades into specific pool trades, the industry has adopted a forty-eight hour rule that is designed to facilitate the exchange of trading details in the forty-eight hour period prior to the settlement date. Unfortunately, many firms tend to exchange such trading details late in the forty-eight hour period and therefore many firms cannot actually handle the conversions.

Further problems with trades and settlements thereof are experienced by the buy-side firms and their custodial banks, who are simply unable to handle the volume of pools during the forty-eight hour period. To reduce volume, buy-side firms are requesting larger pool sizes. While larger pool sizes do reduce the amount of processing on settlement, the overall trade price tends to increase for the buyer.

Even worse, failed trades tend to exacerbate problems in following months. As is well understood by those of skill in the art, pools, by their very nature, decrease in value as principal and interest are paid. For example, a pool having a current face value of $25,000 in one month can be worth less than $25,000 in a following month. Currently, the way to remove these pools is to sell them as “non-good” delivery pools, for a price lower than the existing market value.

A still further problem arises with the need for buy-side firms to maintain sub-accounts for certain customers—such as pension funds, corporate trusts, insurance companies, etc. The management of sub-accounts further increases the processing load of transactions of MBS in each account. For example, a $500 million TBA trade may in fact represent settlement of more than a thousand individual sub-accounts and correspond to more than a thousand clearance events. Such a $500 million TBA trade may therefore be broken into a number of pieces, compounding the problem. While a buy-side firm can hold the same pool in all sub-accounts, it cannot combine these pools due to existing laws. Even once these settlements and clearances are processed, the buy-side firm still needs to process all monthly principal and interest payments for these sub-accounts—further adding to the processing burden of the buy-side firm. A still further burden for buy side firms is the fact that buy side firms often have numerous custodial banks, thereby further compounding the problems associated with prior art MBS trading practices.

Other problems also currently exist in the MBS industry and with prior art methods of trading. In particular, failed trades often lead to a so-called “round robin” scenario wherein a pool of funds is shifted from one financial institution to another. While this can help a financial institution to temporarily deal with a failed trade, it is not a permanent answer. Round robins particularly arise in the context of the MBS industry due to the allocation of pool issues. For example, financial institution A sells to financial institution B, which in turn sells to financial institution C and so on, until the ultimate firm which is failing initiates the delivery process. However, if there is a delay in the initial firm making delivery, then the ripple effect of failed deliveries reverberates throughout the industry. This has placed an undue burden on the operation staffs of both buy- and sell-side firms. The net result can be seen in the growing concern among industry participants as to the volume of trades, and the increasing length of time that these trades remain unsettled. To date, industry efforts to alleviate problems arising from round robins have been unsuccessful in addressing the failed delivery issue. Finding a solution to the problem is made difficult due to complex processing procedures and large volumes of trades concentrated on specific settlement dates during the monthly settlement cycle. Manual efforts to resolve these occurrences are time-consuming and labor intensive. The complexity of tracking a round robin for numerous pools can take days, if not weeks to resolve. The tremendous growth in trading volume has substantially increased the amount of deliveries processed each month by industry participants.

A still further problem in the MBS industry is that the fail confirmation process is currently conducted by individual financial organizations at the end of each month. The fail confirmation process is important as it ensures that firms verify and confirm their open fails. Open fails can potentially represent a trading risk if there is a significant movement in the market from the original trade date to the current date. Market movement can cause exposure to risk if either side of the fail is not aware of the trade. When this occurs, it can force the acknowledging firm to enter into the open market and purchase the securities needed to close the fail. While the price difference can be a profit or loss, it is still an exposure or risk. Other inefficiencies and problems exist with the MBS industry, including the need for a borrow market and improved handling of pool substitution.

In general, heavy trading volume, increased processing flows, and overall system delays have caused tremendous problems in the MBS industry. An automated system for processing, settling and tracking the trading of MBS is needed in the MBS industry.

### SUMMARY OF THE INVENTION

It is an object of the present invention to provide a novel system and method for trading that obviates or mitigates one or more of the above-identified disadvantages of the prior art.

An aspect of the invention provides a computer-based system for processing MBS comprising a server operable to receive at least one inventory of MBS. The inventory is of a format that includes indicia associated with each of the MBS to be stored in the inventory. The server is operable to generate at least one transaction based on an analysis of the at least one inventory.

Another aspect of the invention provides a computer-based method for processing MBS comprising the steps of:
receiving at least one inventory of MBS from an institution, the inventory including indicia associated with each of said MBS;
performing at least one transaction based on an analysis of the at least one inventory;
returning a result of the transaction to the institution.

Another aspect of the invention provides a system for trading including a plurality of workstations interconnected by a consolidating server. The workstations receive data representing inventories of their MBS pools, which in turn are delivered to the consolidating server. The consolidating server, in turn, is operable to combine like MBS pools into consolidated MBS pools. The consolidating server is operable to convert the consolidated pools into specific trades, which can then be settled. The consolidating server is also operable to present the consolidated pools to the workstations for sale, and to attribute appropriate portions of such sales back to the originating workstations.

### BRIEF DESCRIPTION OF THE DRAWINGS

The invention will now be described by way of example only, and with reference to the accompanying drawings, in which:

FIG. 1 is a schematic representation of a system for trading in accordance with an embodiment of the invention;

FIG. 2 is a flowchart depicting a method of consolidating a security in accordance with another embodiment of the invention; and,

FIG. 3 is a flowchart depicting a number of substeps that can be performed when performing the method in FIG. 2.

### DETAILED DESCRIPTION OF THE INVENTION

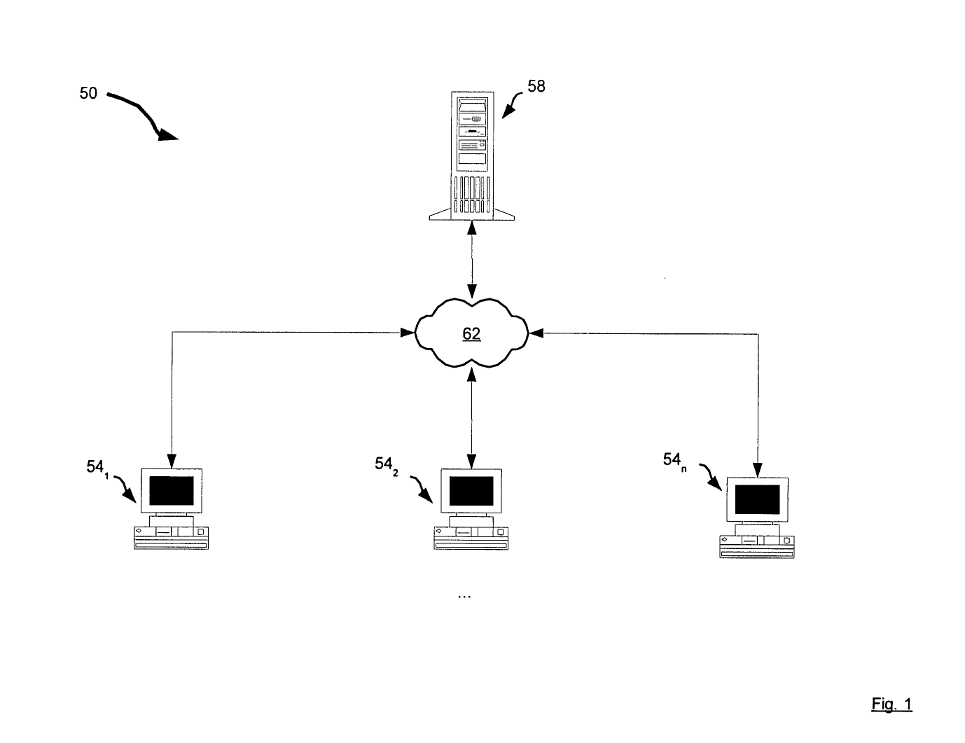

Referring now to FIG. 1, a system for trading in accordance with an embodiment of the invention is indicated generally at 50. System 50 comprises a plurality of financial institution workstations 54₁, 54₂, 54ₙ (generically referred to herein as workstation(s) 54) all of which are connected to a consolidating server 58 through the Internet 62 or other suitable network.

Each workstation 54 belongs to an individual financial institution having an inventory of MBS pools. Workstations 54 can be any type of a computing device operable to conduct communications with server 58 over Internet 62, such as a personal computer having a keyboard and mouse (or other input devices), a monitor (or other output device) and a tower connecting the keyboard, mouse and monitor and including one or more central processing units, random access memory, storage devices and network interfaces to allow the workstation 54 to communicate over Internet 62.

Workstations 54 are operable to receive and/or otherwise maintain in storage user data in their computing environment that is representative of MBS pool inventories to be consolidated. For example, work Table I shows an example of how the user input at each workstation 54 can appear.

TABLE I
Inventory of MBS Pools

| | | | | Field 5 | |
|---|---|---|---|---|---|
| | Field 2 | | Field 4 | Original Face | |
| Field 1 | Financial | Field 3 | Pool | Value | Field 6 |
| Entry # | institution | Agency | Number | (×$1000) | Coupon |
| 1 | ABC | FNMA | 000001 | $200.00 | 5.0% |

In the present embodiment, Table I includes seven columns. Field 1, “Entry Number”, is simply an index of the particular MBS pool in the financial institution's inventory. Field 2, “Financial Institution”, is the name of the financial institution that operates the workstation 54 that owns the inventory being uploaded to server 58 for consolidation. Field 3, “Agency”, is the name of the agency that issued the relevant pool. Examples of Agencies include FNMA, GNMA and FHLMC. Field 4, “Pool Number”, is an identifier of a specific pool of an MBS that is assigned by the Agency. Field 5, “Original Face Value”, is the value of the pool identified in Field 4 when that particular pool was purchased by the financial institution's client. Field 6, “Coupon”, is the interest rate of the pool identified in Field 4.

Thus, Entry Number 1 of Table I identifies a financial institution called “ABC”, and a pool issued by FNMA, bearing pool number 001, having an original face value of $200,000 and an interest rate of 5.0%.

Those of skill in the art will now recognize that the format in Table I is merely exemplary, and that a variety of other fields can be used in addition to, or in lieu of, the specific fields identified in Table I. For example, it should now be apparent that Field 6, “Coupon”, can actually be omitted, as the coupon of a given MBS can be derived from the Agency and Pool Number. By the same token, where a particular pool identified in Field 4 has been assigned a number by the Committee on Uniform Securities Identification Procedures (“CUSIP”) (“CUSIP Number”), then several other values in Table I (and a number of additional values pertaining to that pool) can be derived from that CUSIP Number. For purposes of explaining certain present embodiments, however, the format of Table I will be used in the discussion hereinbelow.

Consolidating server 58 is any type of computing device operable to conduct communications with workstations 54 over Internet 62, such as a computer having a keyboard and mouse (or other input devices), a monitor (or other output device) and a tower connecting the keyboard, mouse and monitor and including one or more central processing units, random access memory, storage devices and network interfaces to allow the server 58 to communicate over Internet 62. Typically, the central processing units, random access memory, operating system, etc., for server 58 are chosen to provide server 58 with enough computing power to handle communications and processing of inputs from the workstations 54 connected to server 58. Thus, for a greater number of workstations 54, it is typical to increase the amount of computing power available in server 58. Server 58 is operable to receive inventories of MBS pools (such as inventories presented in the format shown in Table I) from workstations 54, and to perform a consolidation thereof, and/or manage trades thereof, as will be explained in greater detail below.

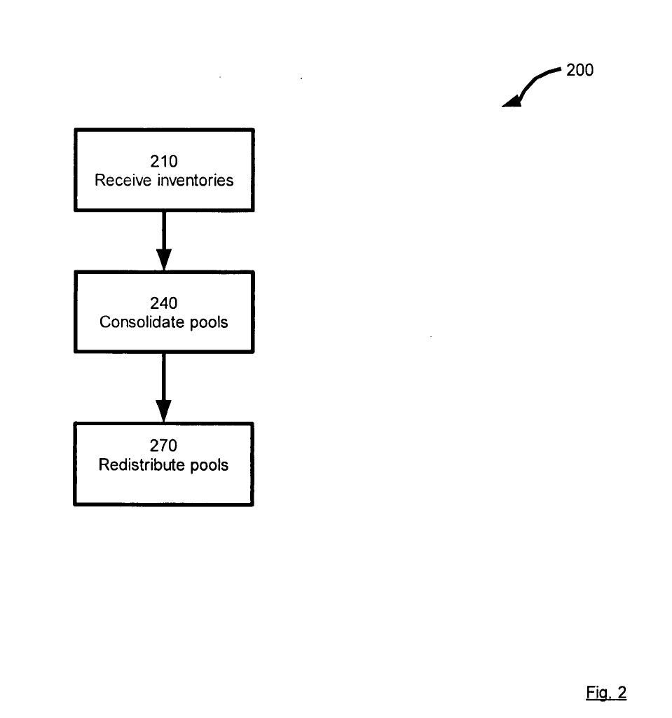

Referring now to FIG. 2, a method for consolidating securities is indicated generally at 200. In order to assist in the explanation of the method, it will be assumed that method 200 is operated using system 50. Furthermore, the following discussion of method 200 will lead to a further understanding of system 50 and its various components. (However, it is to be understood that system 50 and/or method 200 can be varied, and need not work exactly as discussed herein in conjunction with each other, and that such variations are also within the scope of the present invention).

Beginning first at step 210, inventories of MBS pools are received into the system. When implemented on system 50, financial institutions operating their respective workstations 54 will access server 58 via Internet 62 and upload their inventories of MBS pools to consolidation server 58 using a web-interface, FTP upload or any other appropriate means.

To assist in explaining method 200, it will be assumed that only two workstations 54₁ and 54₂ are participating in method 200, and that they are uploading their inventories to server 58. Table II shows an example inventory belonging to the financial institution operating workstation 54₁, while Table III shows an example inventory belonging to the financial institution operating workstation 54₂. It is to be understood that the examples in Tables II and III are simplified to facilitate explanation of the present embodiments.

TABLE II
Inventory of MBS Pools entered at workstation 54₁

| | Field 2 | | | | |
|---|---|---|---|---|---|
| | Financial | | | Field 5 | |
| | institution | | Field 4 | Original Face | |
| Field 1 | (operator of | Field 3 | Pool | Value | Field 6 |
| Entry # | Workstation 54₁) | Agency | Number | (×$1000) | Coupon |
| 1 | ABC | FNMA | 000001 | $200.00 | 5.0% |
| 2 | ABC | FNMA | 000002 | $200.00 | 5.0% |
| 3 | ABC | GNMA | 000101 | $300.00 | 6.0% |
| 4 | ABC | GNMA | 000102 | $300.00 | 6.0% |

TABLE III
Inventory of MBS Pools entered at workstation 54₂

| | Field 2 | | | | |
|---|---|---|---|---|---|
| | Financial | | | Field 5 | |
| | institution | | Field 4 | Original Face | |
| Field 1 | (operator of | Field 3 | Pool | Value | Field 6 |
| Entry # | Workstation 54₂) | Agency | Number | (×$1000) | Coupon |
| 1 | XYZ | FNMA | 000001 | $200.00 | 5.0% |
| 2 | XYZ | FNMA | 000002 | $200.00 | 5.0% |
| 3 | XYZ | GNMA | 000101 | $300.00 | 6.0% |
| 4 | XYZ | GNMA | 000102 | $300.00 | 6.0% |

It is thus assumed that, at step 210, the information in Table II is entered into workstation 54₁ (or is otherwise already available on workstation 54₁) and uploaded over Internet 62 where it is received by server 58. By the same, token, it is also assumed that at step 210, the information in Table III is entered into workstation 54₂ (or is, otherwise already available on workstation 54₂) and uploaded over Internet 62 where it is received by server 58.

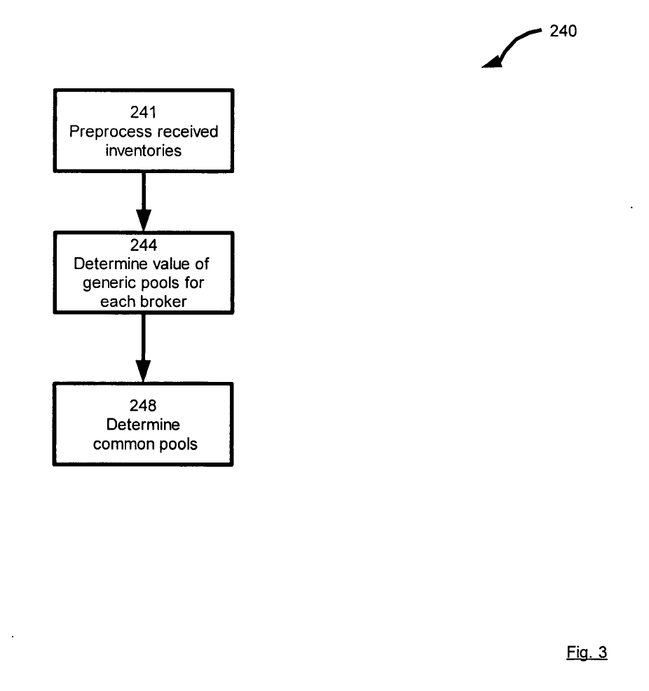

Referring again to method 200 in FIG. 2, after step 210 the method advances to step 240, at which point the pools received at step 210 are consolidated. The operations and means to perform step 240 are not particularly limited, and are typically performed over a number of sub-steps. FIG. 3 shows step 240 in greater detail, identifying a number of sub-steps that can be used to perform step 240. Referring now to FIG. 3, at step 241 the inventories that were received at step 210 are preprocessed. In particular, the inventories are combined into a single table and sorted so that like pools can be grouped and eventually consolidated. Table IV shows this preprocessing in greater detail, as Tables II and III are combined.

TABLE IV
Combined Inventories of MBS Pools received at step 210

| | | | | Field 5 | |
|---|---|---|---|---|---|
| | Field 2 | | Field 4 | Original Face | |
| Field 1 | Financial | Field 3 | Pool | Value | Field 6 |
| Entry # | institution | Agency | Number | (×$1000) | Coupon |
| 1 | ABC | FNMA | 000001 | $200.00 | 5.0% |
| 2 | ABC | FNMA | 000002 | $200.00 | 5.0% |
| 3 | ABC | GNMA | 000101 | $300.00 | 6.0% |
| 4 | ABC | GNMA | 000102 | $300.00 | 6.0% |
| 5 | XYZ | FNMA | 000001 | $200.00 | 5.0% |
| 6 | XYZ | FNMA | 000002 | $200.00 | 5.0% |
| 7 | XYZ | GNMA | 000101 | $300.00 | 6.0% |
| 8 | XYZ | GNMA | 000102 | $300.00 | 6.0% |

Table V shows further preprocessing done at step 241, as the inventories in Table IV are sorted by Agency, Coupon and Pool Number.

TABLE V
Sorted Inventories of MBS Pools received at step 210

| | Field 2 | | Field 4 | Field 5 | |
|---|---|---|---|---|---|
| Field 1 | Financial | Field 3 | Pool | Original Face Value | Field 6 |
| Entry # | institution | Agency | Number | (×$1000) | Coupon |
| 1 | ABC | FNMA | 000001 | $200.00 | 5.00% |
| 5 | XYZ | FNMA | 000001 | $200.00 | 5.00% |
| 2 | ABC | FNMA | 000002 | $200.00 | 5.00% |
| 6 | XYZ | FNMA | 000002 | $200.00 | 5.00% |
| 3 | ABC | GNMA | 000101 | $300.00 | 6.00% |
| 7 | XYZ | GNMA | 000101 | $300.00 | 6.00% |
| 4 | ABC | GNMA | 000102 | $300.00 | 6.00% |
| 8 | XYZ | GNMA | 000102 | $300.00 | 6.00% |

The results of the preprocessing shown in Table V thus indicate that Entry Numbers 1 and 5; Entry Numbers 2 and 6; Entry Numbers 3 and 7; and Entry Numbers 4 and 8 have common Pool Numbers, and therefore can be good candidates for consolidation.

The results of the preprocessing shown in Table V also indicate that Entry Numbers 1, 5, 2 and 6; and Entry Numbers 3, 7, 4 and 8 have common generic trade characteristics, in that the Agency and Coupon are the same, and are therefore potential candidates for redistribution.

Referring again to FIG. 3, at step 244 the value of pools with common generic trade characteristics, for each financial institution, are determined. Table VI shows the results of partially performing step 244. Table VI shows Table IV sorted according to Financial Institution, Agency and Coupon.

TABLE VI
Common Generic Trade Characteristics of MBS Pools received at step 210

| | Field 2 | | Field 4 | Field 5 | |
|---|---|---|---|---|---|
| Field 1 | Financial | Field 3 | Pool | Original Face Value | Field 6 |
| Entry # | institution | Agency | Number | (×$1000) | Coupon |
| 3 | ABC | GNMA | 000101 | $300.00 | 6.00% |
| 4 | ABC | GNMA | 000102 | $300.00 | 6.00% |
| 2 | ABC | FNMA | 000002 | $200.00 | 5.00% |
| 1 | ABC | FNMA | 000001 | $200.00 | 5.00% |
| 7 | XYZ | GNMA | 000101 | $300.00 | 6.00% |
| 8 | XYZ | GNMA | 000102 | $300.00 | 6.00% |
| 5 | XYZ | FNMA | 000001 | $200.00 | 5.00% |
| 6 | XYZ | FNMA | 000002 | $200.00 | 5.00% |

The results shown in Table VI indicate that Entry Numbers 3 and 4 and Entry Numbers 2 and 1 have common generic trade characteristics for Financial institution ABC, while Entry Numbers 7 and 8, and Entry Numbers 5 and 6 have common generic trade characteristics for Financial institution XYZ. Table VII shows Table VI with these common generic trades grouped and totaled. Table VII includes an additional Field, Field 7, “Total Generic Value”, that totals the Original Face Value for each grouping of common generic trades belonging to a particular financial institution.

TABLE VII
Common Generic Trade Characteristics of MBS Pools received at step 210

| | | | | | | Field 7 |
|---|---|---|---|---|---|---|
| | Field 2 | | Field 4 | Field 5 | | Total Generic |
| Field 1 | Financial | Field 3 | Pool | Original Face Value | Field 6 | Value |
| Entry # | institution | Agency | Number | (×$1000) | Coupon | (×$1000) |
| G1 | | | | | | |
| 3 | ABC | GNMA | 000101 | $300.00 | 6.00% | |
| 4 | ABC | GNMA | 000102 | $300.00 | 6.00% | $600.00 |
| G2 | | | | | | |
| 2 | ABC | FNMA | 000002 | $200.00 | 5.00% | |
| 1 | ABC | FNMA | 000001 | $200.00 | 5.00% | $400.00 |
| G3 | | | | | | |
| 7 | XYZ | GNMA | 000101 | $300.00 | 6.00% | |
| 8 | XYZ | GNMA | 000102 | $300.00 | 6.00% | $600.00 |
| G4 | | | | | | |
| 5 | XYZ | FNMA | 000001 | $200.00 | 5.00% | |
| 6 | XYZ | FNMA | 000002 | $200.00 | 5.00% | $400.00 |

Accordingly, group G1 in Table VII shows that Entry Numbers 3 and 4 have common generic trade characteristics for Financial Institution ABC, with a total value of $600.00. Group G2 shows that Entry Numbers 2 and 1 have common generic trade characteristics for Financial Institution ABC, with a total value of $400.00. Group G3 shows that Entry Numbers 7 and 8 have common generic trade characteristics for Financial Institution XYZ, with a total value of $600.00. Group G4 shows that Entry Numbers 5 and 6 have common generic trade characteristics for Financial Institution XYZ, with a total value of $400.00.

Expressed in other words, Table VII indicates that Financial Institution ABC has one set of pools representing a generic trade of GNMA at 6.0% totalling $600.00, and a second set of pools representing a generic trade of FNMA at 5.0% totalling $400.00. Likewise, Financial Institution XYZ has one set of pools representing a generic trade of GNMA at 6.0% totalling $600.00, and a second set of pools representing a generic trade of FNMA at 5.0% totalling $400.00.

Having completed step 244 in FIG. 3, the method advances to step 248, at which pools having common Pool Numbers are determined. This matching is represented in Table VIII, which includes the information of Table VII plus an additional field, Field 8, that identifies the corresponding Entry Number where a match exists.

TABLE VIII
Matched Pools MBS Pools

| | | | | Field 5 | | Field 7 | |
|---|---|---|---|---|---|---|---|
| | Field 2 | | Field 4 | Original Face | | Total Generic | Field 8 |
| Field 1 | Financial | Field 3 | Pool | Value | Field 6 | Value | Matching Entry |
| Entry # | institution | Agency | Number | (×$1000) | Coupon | (×$1000) | Number |
| G1 | | | | | | | |
| 3 | ABC | GNMA | 000101 | $300.00 | 6.00% | | 7 |
| 4 | ABC | GNMA | 000102 | $300.00 | 6.00% | $600.00 | 8 |
| G2 | | | | | | | |
| 2 | ABC | FNMA | 000002 | $200.00 | 5.00% | | 6 |
| 1 | ABC | FNMA | 000001 | $200.00 | 5.00% | $400.00 | 5 |
| G3 | | | | | | | |
| 7 | XYZ | GNMA | 000101 | $300.00 | 6.00% | | 3 |
| 8 | XYZ | GNMA | 000102 | $300.00 | 6.00% | $600.00 | 4 |
| G4 | | | | | | | |
| 5 | XYZ | FNMA | 000001 | $200.00 | 5.00% | | 2 |
| 6 | XYZ | FNMA | 000002 | $200.00 | 5.00% | $400.00 | 1 |

Having completed step 248, and by extension, step 240, method 200 then advances to step 270 as shown in FIG. 2. At step 270, the results of steps 210 and 240 are used to redistribute consolidated pools back to the financial institutions. Server 58 will use the information contained in Tables IV-VII to return pools back to the financial institutions in a manner that preserves the original value of the financial institution's inventory. In particular, server 58 will use Field 8, “Matching Number Entry” of Table VIII, in conjunction with the Field 7, “Total Generic Value” of Table VIII, to provide each financial institution with a reduced number of pools for their inventory, wherein that reduced number of pools has the same original face value as when the MBS inventory was originally submitted at step 210. Table IX represents part of the performance of step 248, and includes the information from Table VIII, and includes Field 9, “Redistribute?”. Each entry under Field 9 indicates “Y”, for “yes”, i.e., that the particular pool associated with that Entry Number will be redistributed, or “N”, for “no”, i.e., that the particular pool associated with that Entry Number will not be redistributed.

TABLE IX
Redistribution of MBS Pools

| | | | | Field 5 | | Field 7 | | | |
|---|---|---|---|---|---|---|---|---|---|
| | Field 2 | | | Original | | Total | Field 8 | | Field 10 |
| | Old | | Field 4 | Face | | Generic | Matching | | New |
| Field 1 | Financial | Field 3 | Pool | Value | Field 6 | Value | Entry | Field 9 | Financial |
| Entry # | institution | Agency | Number | (×$1000) | Coupon | (×$1000) | Number | Redistribute? | institution |
| G1 | | | | | | | | | |
| 3 | ABC | GNMA | 000101 | $300.00 | 6.00% | | 7 | N | ABC |
| 4 | ABC | GNMA | 000102 | $300.00 | 6.00% | $600.00 | 8 | Y | XYZ |
| G2 | | | | | | | | | |
| 2 | ABC | FNMA | 000002 | $200.00 | 5.00% | | 6 | N | ABC |
| 1 | ABC | FNMA | 000001 | $200.00 | 5.00% | $400.00 | 5 | Y | XYZ |
| G3 | | | | | | | | | |
| 7 | XYZ | GNMA | 000101 | $300.00 | 6.00% | | 3 | Y | ABC |
| 8 | XYZ | GNMA | 000102 | $300.00 | 6.00% | $600.00 | 4 | N | XYZ |
| G4 | | | | | | | | | |
| 5 | XYZ | FNMA | 000001 | $200.00 | 5.00% | | 1 | Y | ABC |
| 6 | XYZ | FNMA | 000002 | $200.00 | 5.00% | $400.00 | 2 | N | XYZ |

Having marked certain pools for redistribution in Table IX, the pools are then redistributed, in their consolidated form, as represented in Table X.

TABLE X
Redistribution of MBS Pools

| | | | | Field 5 | | |
|---|---|---|---|---|---|---|
| Field 1 | Field 2 | | Field 4 | New Face | | Field 7 |
| New | Financial | Field 3 | Pool | Value | Field 6 | Old Entry |
| Entry # | institution | Agency | Number | (×$1000) | Coupon | #s |
| 1 | ABC | GNMA | 000101 | $600.00 | 6.00% | 3 and 7 |
| 2 | ABC | FNMA | 000001 | $400.00 | 5.00% | 1 and 5 |
| 3 | XYZ | GNMA | 000102 | $600.00 | 6.00% | 4 and 8 |
| 4 | XYZ | FNMA | 000002 | $400.00 | 5.00% | 2 and 6 |

Thus, the redistributed pools as shown in Table. X for financial institution ABC and financial institution XYZ can be sent from server 58 to the corresponding workstation 54₁ and workstation 54₂ via Internet 62. Table XI shows the Inventory of MBS Pools for financial institution ABC after redistribution, and Table XII shows the Inventory of MBS Pools for financial institution XYZ after redistribution.

TABLE XI
Inventory of redistributed MRS Pools sent to workstation 54₁

| | Field 2 | | | | |
|---|---|---|---|---|---|
| | Financial | | | Field 5 | |
| | institution | | Field 4 | Original Face | |
| Field 1 | (operator of | Field 3 | Pool | Value | Field 6 |
| Entry # | Workstation 54₁) | Agency | Number | (×$1000) | Coupon |
| 1 | ABC | GNMA | 000101 | $600.00 | 6.00% |
| 2 | ABC | FNMA | 000001 | $400.00 | 5.00% |

TABLE XII
Inventory of MBS Pools entered at workstation 54₂

| | Field 2 | | | | |
|---|---|---|---|---|---|
| | Financial | | | Field 5 | |
| | institution | | Field 4 | Original Face | |
| Field 1 | (operator of | Field 3 | Pool | Value | Field 6 |
| Entry # | Workstation 54₂) | Agency | Number | (×$1000) | Coupon |
| 1 | XYZ | GNMA | 000102 | $600.00 | 6.00% |
| 2 | XYZ | FNMA | 000002 | $400.00 | 5.00% |

At this point method 200 terminates, and can begin anew in order to consolidate other pools at different times, as desired.

It is to be understood that many variants, enhancements and modifications can be effected to the above-described system 50 and method 200 as desired. Of particular note, those of skill in the art will now recognize that method 200 would be performed in advance of any predefined settlement dates. Additionally, after consolidation of pools, trading of such pools can be effected in the usual manner. It is also contemplated that a fee will be charged (or ether means of consideration obtained) by the operator of server 58 to each financial institution participating in the method 200.

It is to be reiterated that the examples shown in Tables I-XII are simplified, and that when system 50 is actually implemented, the number of participating financial institutions will typically be much greater than two, and that the size of the inventories held by those institutions can contain hundreds or thousands of entries. Accordingly, it is to be understood that additional steps can be added to method 200 to accommodate specific complexities that can arise when processing such large volumes. One approach is iterative, using a process that determines which pools are to be removed from some financial institutions, consolidated and redistributed to others. Each iteration can involve examining the original face value of a generic pool for a first financial institution, and then examining the inventories of all other institutions until a match of one or more other pools can be found from those other institutions, which can then be consolidated and redistributed back to that first financial institution. By the same token, it can be desired to split certain large pools that originate from one or more financial institutions into a number of smaller pools to satisfy the needs of other institutions that are unable to use such a large pool on their own. It is also contemplated that in many circumstances, certain pools will not be successfully consolidated and so such pools can simply be returned in their original form to the financial institution that originally submitted those non-consolidated pools. It should now be understood that a number of specific implementations of consolidation and redistribution, all within the scope of the invention, can be effected as desired.

Furthermore, while Table I shows one type of inventory format, it is to be reiterated that other types of information can be included in an inventory upload, to provide enhancements to method 200. For example, it can be desired to upload other pool indicia such as the factor date, factor rate, maturity date, current weighted average maturity (“WAM”), weighted average coupon (“WAC”), constant payment rate (“CPR”), net proceeds of a trade, transaction ID number, and/or buy and sell indicators. Alternatively, where a CUSIP Number, or Agency and Pool Number is provided, the information such as WAM and WAC can be derived implicitly, without the need for uploading, from publicly available databases identifying such information associated with the CUSIP number, or Agency and Pool Number. By the same token, it can be desired to allow financial institutions to upload their own criteria for the types of indicia they would like to see in any pools that are redistributed to them, thereby allowing financial institutions to more choice in the criteria used in the consolidation and redistribution of pools back to those financial institutions.

It can also be desired to allow a financial institution to indicate any particular pools in their inventory that they expressly wish to “retain”, i.e., that the financial institution does not wish to be “taken” from their inventory during consolidation and redistribution (“retained pools”). In this manner, the financial institution may also effectively indicate that it is interested in having previously retained pools augmented, in favour of abandoning other pools. Thus, during the consolidation and redistribution, pools marked “retained” by one financial institution will not be considered for redistribution to another financial institution. Conversely, during the consolidation and redistribution, consolidation server 58 will attempt to augment pools marked “retained” with available pools from other financial institutions. Where multiple financial institutions each mark the same pool for such retention, then it can be desired to include a rule that prioritizes one institution over another for augmentation—for example, on a first-in first-out basis. Alternatively, such a rule can attempt to share (equally or on another basis) the augmentation of retained pools between different financial institutions that wish to retain the same pool. Additional rules can also be applied, such as ensuring that the submitted original face value of the pool that is to be retained is actually less than or equal to the original face value of the generic version of that pool.

Furthermore, it can also be desired to vary the performance of step 241 by validating each entry in the submitted inventory. For example, such validation can involve verifying that the submitted Coupon Rate for a particular Pool Number is the correct Coupon Rate as specified by the issuing Agency and/or information publicly available from Standard & Poors or other rating authority.

It is also to be understood that system 50 and method 200 can be modified to accommodate financial institutions that manage a number of different accounts for individual clients. Table XIII shows a simplified example of the inventory that can be uploaded at a given workstation 54 by “ABC Financial Institution” that includes two different accounts being handled by ABC Financial Institution.

TABLE XIII
Inventory of MBS Pools

| | | | | | Field 5 | |
|---|---|---|---|---|---|---|
| Field | | | | | Original | |
| 1 | Field 2 | Field2A | | Field 4 | Face | |
| Entry | Financial | Account | Field 3 | Pool | Value | Field 6 |
| # | institution | Holder | Agency | Number | (×$1000) | Coupon |
| 1 | ABC | DEF | FNMA | 000001 | $200.00 | 5.0% |
| | | Investment | | | | |
| | | fund | | | | |
| 2 | ABC | DEF | FNMA | 000002 | $200.00 | 5.0% |
| | | Investment | | | | |
| | | Fund | | | | |
| 3 | ABC | GHI | FNMA | 000001 | $200.00 | 5.0% |
| | | Teachers | | | | |
| | | fund | | | | |
| 4 | ABC | GHI | FNMA | 000002 | $200.00 | 5.0% |
| | | Teachers | | | | |
| | | fund | | | | |

More particularly, Table XIII includes an additional field, Field 2A, called “Account Holder”. Entries 1 and 2 of Table XIII show pools belonging to the account held by DEF Investment Fund, while Entries 3 and 4 shows pools belonging to the account held by GHI Investment Fund. Assuming that a modified version of method 200 is performed on an upload of Table XIII only, Table XIV shows the results of the consolidation of pools performed using a suitably modified version of method 200 on the inventory of Table XIII.

TABLE XIV
Example Redistribution of Inventory in Table XIII

| | | | | | Field 5 | |
|---|---|---|---|---|---|---|
| Field | | | | | Original | |
| 1 | Field 2 | Field2A | | Field 4 | Face | |
| Entry | Financial | Account | Field 3 | Pool | Value | Field 6 |
| # | institution | Holder | Agency | Number | (×$1000) | Coupon |
| 1 | ABC | DEF | FNMA | 000001 | $400.00 | 5.0% |
| | | Investment | | | | |
| | | fund | | | | |
| 2 | ABC | GHI | FNMA | 000002 | $400.00 | 5.0% |
| | | Teachers | | | | |
| | | fund | | | | |

It should now be apparent that a plurality of workstations 54 belonging to different financial institutions could upload tables with data of the format of Table XIII to consolidation server 58, and, accordingly, consolidation server 58 can be operable to consolidate and redistribute pools among different Accounts held by different financial institutions.

While only specific combinations of the various features and components of the present invention have been discussed herein, it will be apparent to those of skill in the art that desired subsets of the disclosed features and components and/or alternative combinations of these features and components can be utilized, as desired. Of particular note, while system 50 and method 200 as described above are directed to consolidation of pools, in other embodiments of the invention other types of trading and/or inventory processing can be effected, such as a process of confirming fails. This can be effected by adding an additional field to the fields in Table I that identify that a particular trade of a pool failed at an earlier date. This failure can then be reported so that the failure can be resolved in an efficient manner, such as by contacting the financial institutions that were to have effected the trade so that the trade can be completed, or so that the party with the failure can be readily able to track which failures need to be addressed by effecting substantially the same trade with another party as soon as possible.

Another example of inventory processing that can be effected using the present invention is the resolution of a round robins. In this variation, round robins can be resolved by including additional fields to the fields in Table I that identify failed-to-receive trades and failed-to-deliver trades. These failed-to-receive trades and failed-to-deliver trades would then be located, using an appropriate modification of method 200, by the Pool Number associated with that type of failure. After consolidation, server 58 reports to each financial institution the results of the consolidated failures, and identifies net monies that are owed and due to and by each financial institution. In the end, server 58 is able to combine a given round robin into a single net amount.

Another example of inventory processing that can be effected using the present invention is the creation of a borrow market for MBS. Using the teachings described above, consolidation server 58 will inherently possess a vast amount of information about the current MBS marketplace, thereby offering a forum for a borrowing marketplace for MBS. Such a borrow market can be particularly useful to efficiently resolve failed transactions and thereby reduce exposure caused by the failure. A still further example of inventory processing that can be effected using the present invention is the creation of a means for offering pool substitution in the MBS market. When a failure of a trade has been outstanding for a long period of time, it can be desired to substitute a specific pool with another so that the open fail can be resolved in a substantially transparent manner. Using the large amount of data inherently available on consolidation server 58, potential substations, and automation of such substitutions, can be readily implemented on server 58.

It is also contemplated that the embodiments herein can be modified for other types of securities trading, such as fixed income securities and including government securities, municipal bonds, and corporate securities.

The above-described embodiments of the invention are intended to be examples of the present invention and alterations and modifications may be effected thereto, by those of skill in the art, without departing from the scope of the invention which is defined solely by the claims appended hereto.

1. A server for processing failed trades of mortgage-backed securities comprising:
a processing unit operable to receive at least two inventories of mortgage-backed securities from computing devices associated with respective institutions; said inventories including indicia associated with each said mortgage-backed security, said indicia including:
a financial institution uniquely identifying a holder of each mortgage-backed security in each of said inventories;
a Pool Number identifying each said mortgage-backed security;
a value of each said mortgage-backed security;
an indication whether said mortgage-backed security pool was a subject of a failed settlement;
said processing unit further operable to determine, based on said indicia, at least one said mortgage-backed security common to said inventories that reflects a failed trade of said mortgage-backed security between said financial institutions;
said server further operable to generate a report identifying said failed trade.

2. The server according to claim 1 wherein said processing unit is further operable to determine a substitute mortgage-backed security pool from within said inventory that was not a subject of a failed settlement and which can substitute said common mortgage-backed security; said processing unit further operable to include said substitute mortgage-backed security pool.

3. The server of claim 1 wherein said indicia includes an indication that each said institution failed-to-deliver said common mortgage-backed security and failed-to-receive said common mortgage-backed security.

4. The server of claim 3 wherein said processing unit is operable to determine whether said failed trade was a round robin by examining said indicia within said failed trade and determining whether all of said institutions failed-to-deliver to another one of said institutions associated with said failed trade and failed-to-receive from another one of said institutions associated with said failed trade; said processing unit further operable to include an indicator of said round robin in said report.

5. A method of processing failed trades of mortgage-backed securities comprising:
receiving at least two inventories of mortgage-backed securities from computing devices associated with institutions respective to said inventories; said inventories including indicia associated with each said mortgage-backed security, said indicia including:
a financial institution uniquely identifying a holder of each mortgage-backed security in each of said inventories;
a Pool Number identifying each said mortgage-backed security;
a value of each said mortgage-backed security;
an indication whether said mortgage-backed security pool was a subject of a failed settlement;
determining, based on said indicia, at least one said mortgage-backed security common to said inventories that reflect a failed trade of said mortgage-backed security between said financial institutions;
generating a report identifying said failed trade.

6. The method of claim 5 comprising the additional steps of:
determining a substitute mortgage-backed security pool from within said inventory that was not a subject of a failed settlement and which can substitute said common mortgage-backed security;
including said substitute mortgage-backed security pool in said report.

7. The method of claim 6 wherein said indicia includes an indication that each said institution failed-to-deliver said common mortgage-backed security and failed-to-receive said common mortgage-backed security; said method comprising the additional steps of:
determining whether said failed trade was a round robin by examining said indicia within said failed trade, in order to ascertain whether all of said institutions failed-to-deliver to another one of said institutions associated with said failed trade and failed-to-receive from another one of said institutions associated with said failed trade; and,
including an indicator of said round robin in said report.

8. A memory for storing data for access by an application program being executed on a data processing system, comprising:
a data structure stored in said memory, said data structure including information resident in a database used by said application program and including:
an inventory of mortgage-backed securities associated with an institution respective to said inventory; said inventory including indicia associated with each said mortgage-backed security, said indicia including:
a financial institution uniquely identifying a holder of each mortgage-backed security in said inventory;
a Pool Number identifying each said mortgage-backed security;
a value of each said mortgage-backed security;
an indication whether said mortgage-backed security pool was a subject of a failed settlement.

9. The memory of claim 8 wherein said indicia further includes an indication as to whether said institution failed-to-deliver said mortgage-backed security and/or failed-to-receive said mortgage-backed security.

10-77. (canceled)
